(19) United States
(12) Patent Application Publication
(10) Pub. No.: US 2024/0184801 A1
(43) Pub. Date: Jun. 6, 2024

(54) DATA DISCREPANCY DETECTION IN A SENSITIVE DATA REPLICATION PIPELINE

(71) Applicant: INTERNATIONAL BUSINESS MACHINES CORPORATION, ARMONK, NY (US)

(72) Inventors: Shailesh Chandra Jamloki, Noida (IN); Girish V. Mattur, Bangalore (IN)

(21) Appl. No.: 18/062,119

(22) Filed: Dec. 6, 2022

(51) Int. Cl. G06F 16/27; G06F 16/22; G06F 16/25

(52) U.S. Cl. CPC G06F 16/27; G06F 16/2255; G06F 16/258

(57) ABSTRACT

An approach is provided for detecting a data discrepancy in a replication pipeline. During a live data replication process that includes moving logical records in the replication pipeline from a source database to a target database via component(s), a raw record is read from a log entry. A logical record is obtained by converting the raw record. The logical record is moved in the replication pipeline so that a next component receives the logical record. Responsive to obtaining or receiving the logical record, metadata is updated in sorted hashmaps. A data discrepancy is detected between the obtained logical record and the moved logical record by analyzing the updated metadata.

### BACKGROUND

The present invention relates to data replication, and more particularly to detecting data inconsistencies during data replication.

In a data replication scenario, a data change record flows through different stages of a replication pipeline form a source database to a target database. In the different stages, the data change record goes through respective specific functions by which bytes of the data change record are transformed. During a significantly large data replication process, there is a chance that a data change record may experience a data inconsistency (i.e., data duplication or data loss). Known replication products scrape the source database's modified logs to obtain the delta change, and then scrape the accompanying commit log entry for the delta change to convert the delta change into a legitimate operation to be committed on the target database. The order of commit and missing commit is one of the main reasons for data loss.

### SUMMARY

In one embodiment, the present invention provides a computer system that includes one or more computer processors, one or more computer readable storage media, computer readable code stored collectively in the one or more computer readable storage media. The computer readable code includes data and instructions to cause the one or more computer processors to perform operations. The operations include reading a raw record from a log entry, where the reading occurs during a live data replication process that includes moving logical records in a replication pipeline from a source database to a target database via one or more components. The operations further include obtaining a logical record by converting the raw record read from the log entry. The operations further include moving the logical record in the replication pipeline so that a next component receives the logical record. The operations further include in response to obtaining or receiving the logical record, updating metadata in sorted hashmaps. The operations further include detecting a data discrepancy between the obtained logical record and the moved logical record by analyzing the updated metadata.

A computer program product and a method corresponding to the above-summarized computer system are also described and claimed herein.

### BRIEF DESCRIPTION OF THE DRAWINGS

FIG. 1 is a block diagram of a system for detecting a data discrepancy in a sensitive data replication pipeline, in accordance with embodiments of the present invention.

FIG. 2 is a block diagram of modules included in code included in the system of FIG. 1, in accordance with embodiments of the present invention.

FIG. 3 is a flowchart of a process of detecting a data discrepancy in a sensitive data replication pipeline, in accordance with embodiments of the present invention.

FIG. 4 is a block diagram of a data discrepancy detection system that includes specialized hashmaps and that is implemented by code included in the system of FIG. 1, in accordance with embodiments of the present invention.

FIG. 5 is a block diagram of a data discrepancy detection system that includes further details of the system of FIG. 4, in accordance with embodiments of the present invention.

FIG. 6 is an example of hashmap specifications used in the process of FIG. 3 and the systems of FIG. 1, FIG. 4, and FIG. 5, in accordance with embodiments of the present invention.

FIG. 7 is an example of state names used in a hashmap included in the system of FIG. 5, in accordance with embodiments of the present invention.

FIGS. 8A-8B is pseudocode for a process of populating the hashmaps included in the systems of FIG. 4 and FIG. 5, in accordance with embodiments of the present invention.

FIGS. 9A-9B depict examples of entries in the hashmaps included in the systems of FIG. 4 and FIG. 5, in accordance with embodiments of the present invention.

### DETAILED DESCRIPTION

### Overview

In a data replication pipeline, comparing row counts on target and source databases to determine whether the compared row counts match is one way to conclude that data loss has occurred. Determining that updates to a target database that are supposed to be provided by Data Manipulation Language (DML) scripts are not applied to the target is another way to conclude that data loss has occurred. In these cases in which data loss is determined, current techniques are not aware of the stage in the replication pipeline at which the data loss occurred. Issues with data loss and data duplication, which are two categories of data inconsistencies, are usually infrequent but when these issues occur, known techniques have difficulty determining the root causes of the issues. The difficulty in determining the root cause may be related to finding out about the data inconsistency issue after a significant amount of time has passed since the issue started (e.g., multiple days have passed), which results in losing important diagnostic information of the database. Furthermore, conventional replication products log minimal information that is not suitable for investigating data inconsistency issues. Increasing the amount of information logged is very costly and logging user data leads to undesirable privacy issues. Because of these difficulties, current techniques often address the data inconsistencies by having a customer restart their system from scratch. Still further, there can be bugs in a replication product whereby the replication product silently ignores an error in a component and the logical entry is lost. Moreover, there are cases in which a replication product does not honor source database transaction boundaries and may resend the logical entry twice to the target due to a bug existing in the product.

Each category of data inconsistency has a specific set of circumstances that may result in data loss, such as:
start of the replication pipeline was too late
data was filtered out because of a false assumption of the data being out of scope
data was lost because a replication component lost an operation needed in the replication
data was lost because a replication component mistakenly discarded the data
data was stuck at a replication component for various reasons (e.g., non-receipt commit entry)
data duplication occurred because a replication component mistakenly sent the data as out of order

Embodiments of the present invention address the aforementioned unique challenges related to known techniques of data discrepancy detection in a replication pipeline. In one embodiment, a new data discrepancy detection technique is provided which identifies (i) the replication stage at which a database row is not able to reach the target due to a data discrepancy or (ii) the replication component by which a database row is not able to reach the target due to a data discrepancy. The aforementioned identification of the replication stage or component is used to make a checkpoint for each record flowing through the replication pipeline and identify the root cause of the data discrepancy, without impacting the existing data replication, and without performing a data comparison between the source database and the target database. By using the checkpoints to identify the stage in the replication pipeline at which the data discrepancy happened, embodiments described herein facilitate a recovery from the data discrepancy situation. For situations in which bugs in a replication product (i) ignore an error in a component leading to a loss of a logical entry and/or (ii) do not honor source database transaction boundaries that lead to resending the logical entry to the target twice, embodiments described herein helps to uncover these situations in a timely way and helps isolate the error conditions. As used herein, a data discrepancy is an inconsistency in data and includes data duplication, data loss, or a combination of data duplication and data loss. A data discrepancy is also referred to herein as a data inconsistency.

In one or more embodiments, the data discrepancy detection approach described herein (i) can easily identify some data inconsistency scenarios, without slowing down data replication as it is happening for each data change record, and without causing the data replication to fail, (ii) can detect data inconsistencies in other scenarios, but with a performance cost (e.g., causing the data replication to slow down), (iii) cannot detect data inconsistencies in still other scenarios.

In one embodiment, the data discrepancy detection approach described herein (i) is running at all times during which live data replication is occurring; (ii) does not impact performance measurements of the live data replication or a successful completion of the live data replication; and (iii) has memory and central processing unit (CPU) requirements that do not exceed defined manageable limits.

In one embodiment, the implementation of the data discrepancy approach described herein can be in a mode selected from different implementation modes, where the selection is dependent on the user's runtime environment and preferences:

Lite Mode: This is an online mode that operates continuously with live replication but has only basic capabilities. Data collection and analytical processing is limited to a minimum amount. This mode is described in detail herein.

Normal Mode: This is also an online mode, but the user may choose to add other features, such as inconsistency visualization using charts and graphs, AUTO RECOVERY, or identifying bottlenecks in a running process. This mode may be memory and/or CPU-intensive that can be enabled by checking the runtime environment. If this mode causes a slowdown in processing, a pause mode is entered to avoid affecting the live data replication.

Offline Mode: In this mode, the process to discover data inconsistencies does not operate concurrently with live data replication; instead, the user shares the achieve logs for the length of the data discrepancy and subsequently, the Normal or Lite Mode of processing is used only for this subset of logs for testing for data inconsistencies.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 200 for data discrepancy detection in a sensitive data replication pipeline. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

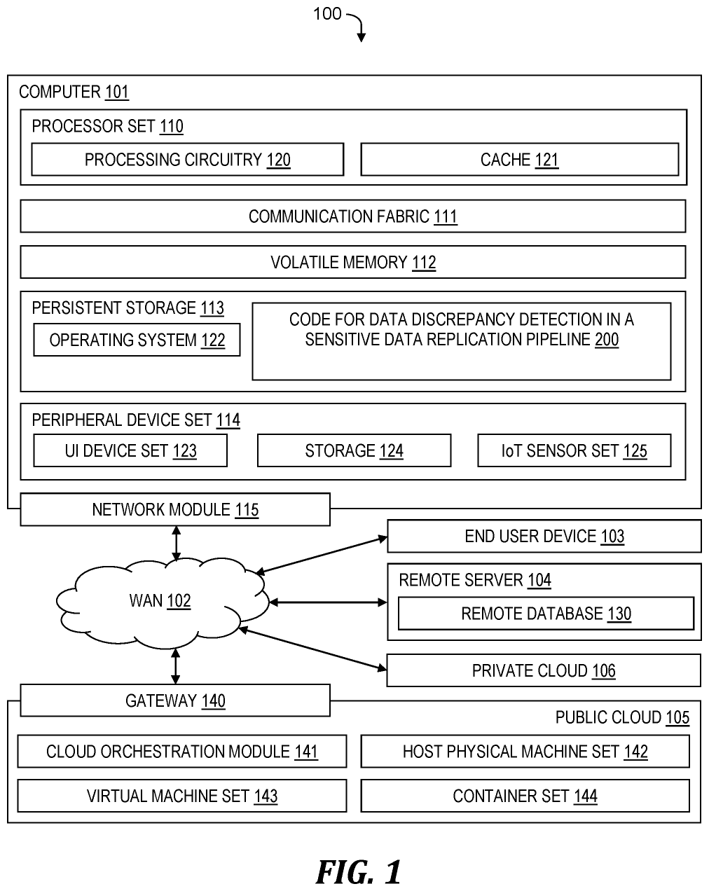

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Data Discrepancy Detection

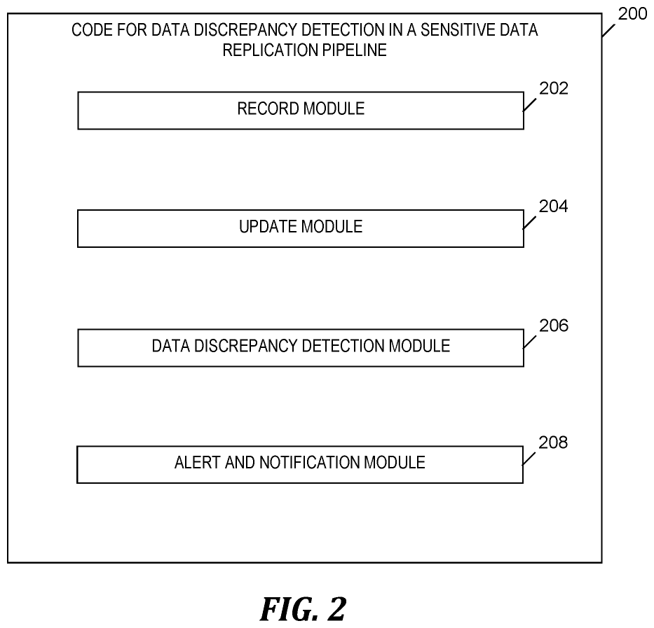

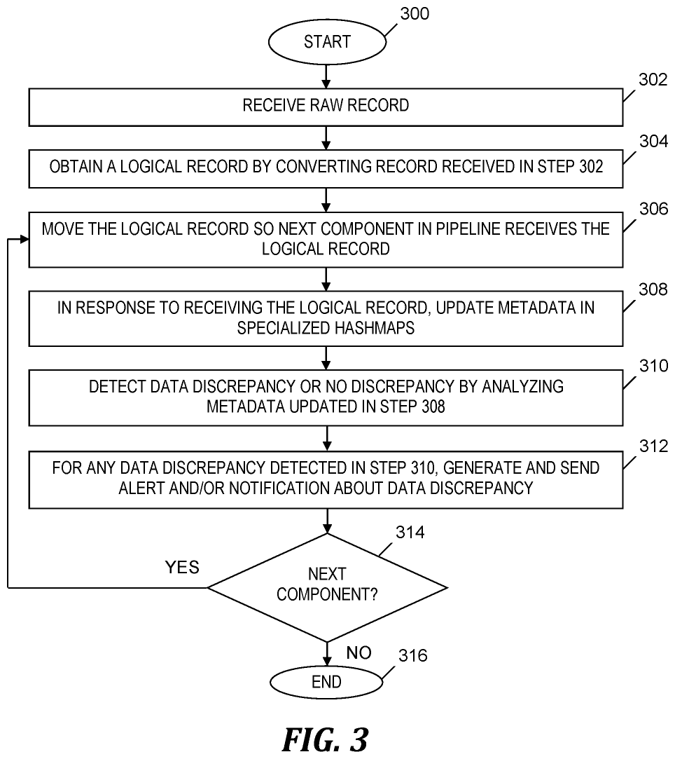

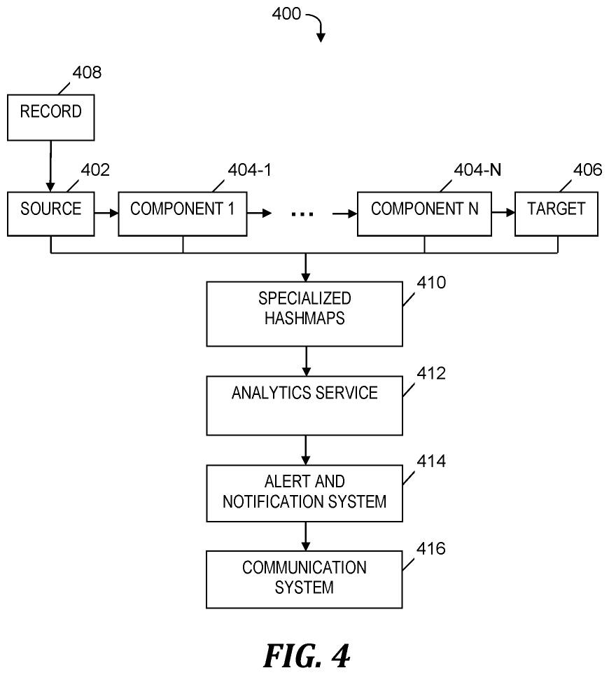

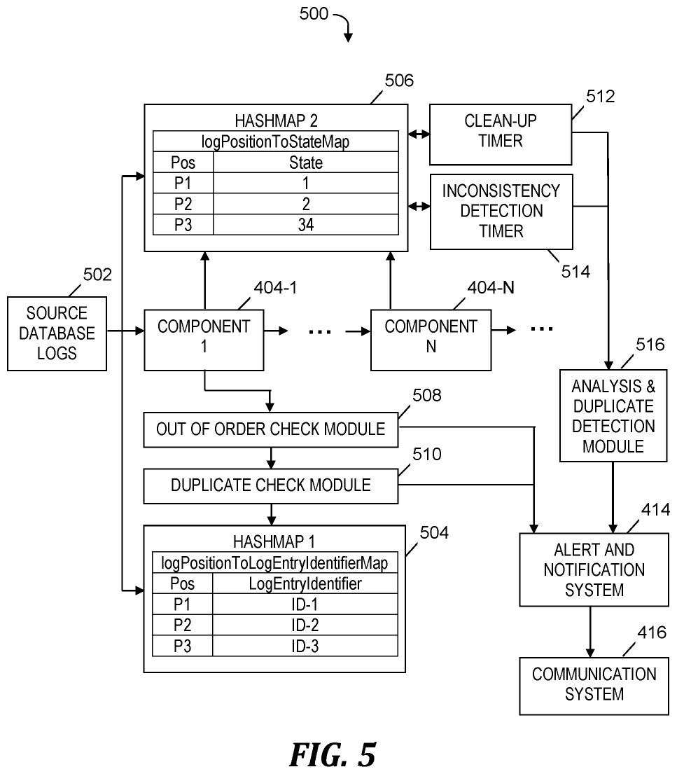

FIG. 2 is a block diagram of modules included in code included in the system of FIG. 1, in accordance with embodiments of the present invention. Code 200 includes a record module 202, an insertion/update module 204, a data discrepancy detection module 206, and an alert and notification module 208. The functionality of the modules included in code 200 is discussed in detail in the discussion of FIG. 3, FIG. 4, and FIG. 5, which is presented below.

FIG. 3 is a flowchart of a process of detecting a data discrepancy in a sensitive data replication pipeline, in accordance with embodiments of the present invention. The process of FIG. 3 begins at a start node 300. The steps that are described herein for FIG. 3 are performed during the running of a data replication (i.e., during a live data replication process that includes moving logical records in a replication pipeline from a source database to a target database via one or more components). In step 302, record module 202 (see FIG. 2) in a source reads a raw record from a log entry.

In step 304, record module 202 obtains a logical record by converting the record read in step 302 to the logical record. After step 304 and prior to step 306, and in response to obtaining the logical record, update module 204 (see FIG. 2) updates metadata for the logical record in specialized hashmaps. The updating of the metadata can include inserting metadata in the specialized hashmaps. The hashmaps are described in detail in the discussion of FIG. 4 and FIG. 5, which are presented below.

In step 306, record module 202 moves the logical record obtained in step 304 to a next component in the sensitive data pipeline, so that the next component receives the logical record.

In step 308, in response to receiving the logical record in step 306, update module 204 updates metadata for the logical record in the aforementioned specialized hashmaps.

In step 310, data discrepancy detection module 206 (see FIG. 2) analyzes the metadata updated in steps 304 and based on the results of the analysis, detects a data discrepancy in the data replication of the logical record at the component that received the logical record in step 306 or detects no data discrepancy associated with the logical record and the component that received the logical record in step 306.

In step 312, for any data discrepancy detected in step 310, alert and notification module 208 generates and sends an alert and/or a notification about the detected data discrepancy to a user via a communication system (e.g., via an email sent by an email system).

In step 314, code 200 determines whether there is a next component in the data replication pipeline to receive the logical record. If code 200 determines in step 314 that there is a next component, then the process of FIG. 3 follows the Yes branch of step 314 and loops back to step 306, as described above.

If code 200 determines in step 314 that there is no next component, then the process of FIG. 3 follows the No branch of step 314 and the process of FIG. 3 ends at an end node 316.

FIG. 4 is a block diagram of a data discrepancy detection system that includes sorted hashmaps and that is implemented in the system of FIG. 1, in accordance with embodiments of the present invention. A data replication pipeline includes a source 402 (i.e., a source database), components 404-1, . . . 404-N (i.e., component 1, . . . , component N), and a target 406 (i.e., a target database), where N is an integer greater than or equal to one. While a data replication is running, source 402 receives and reads a record 408 (e.g., a raw record) which is being replicated as part of the data replication. Source 402 converts the record to a logical record (i.e., a logical log entry). Source 402 moves the logical record to the first component in the replication pipeline (i.e., component 404-1).

Source 402 inserts and/or updates metadata for the logical record in specialized hashmaps 410, which are located in in-memory storage. Specialized hashmaps 410 are sorted hashmaps and self-expiring. A self-expiring hashmap has expiry timer(s) by which the entries of the hashmap expire automatically after a specified time. The specified time can be defined on a per-key basis. The self-expiring feature may use, for example, a DelayQueue internally or a worker thread that periodically checks the entries to determine if any entries are to be removed based on a provided time-to-live value.

Component 404-1 receives the logical record that is moved from source 402. In response to receiving the logical record, component 404-1 updates metadata for the logical record in the specialized hashmaps 410. Component 401-1 moves the logical record to the next component in the replication pipeline, so that the next component receives the logical record and in response thereto, updates metadata for the logical record in specialized hashmaps 410. This movement to and receipt of the logical record at the next component and the updating of the metadata for the logical record is repeated until the final component (i.e., component 404-N) in the replication pipeline receives the logical record and updates the metadata for the logical record in the specialized hashmaps 410.

Component 404-N moves the logical record to target 406 so that target 406 receives the logical record. In response to receiving the logical record, target 406 updates the metadata for the logical record in the specialized hashmaps 410.

After the components 404-1, . . . , 404-N and target 406 receive the logical record and update the metadata, specialized hashmaps 410 uses an analytics service 412 to analyze the updated metadata to determine if there is a data discrepancy, such as a data loss or a data duplication, which involves the logical record. In response to determining that there is a data discrepancy, the analytics service calls the alert and notification system 414 to generate and send and alert and/or notification about the data discrepancy to a user via a communication system 416 (e.g., an email system).

These aforementioned steps of updating metadata in the specialized hashmaps 410, analyzing the updated metadata and determining that there is a data discrepancy by analytics service 412, and generating and sending the alert and/or notification by the alert and notification system are performed during a live data replication that includes replicating the logical record.

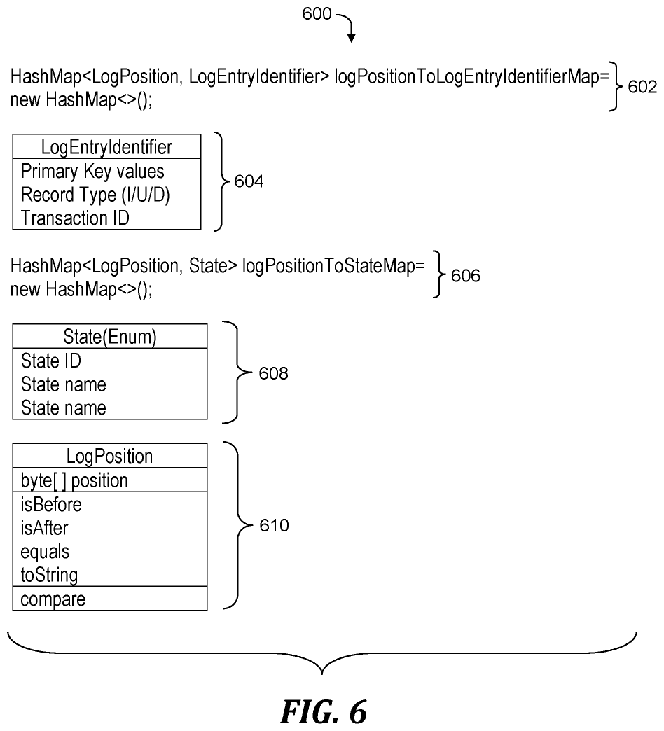

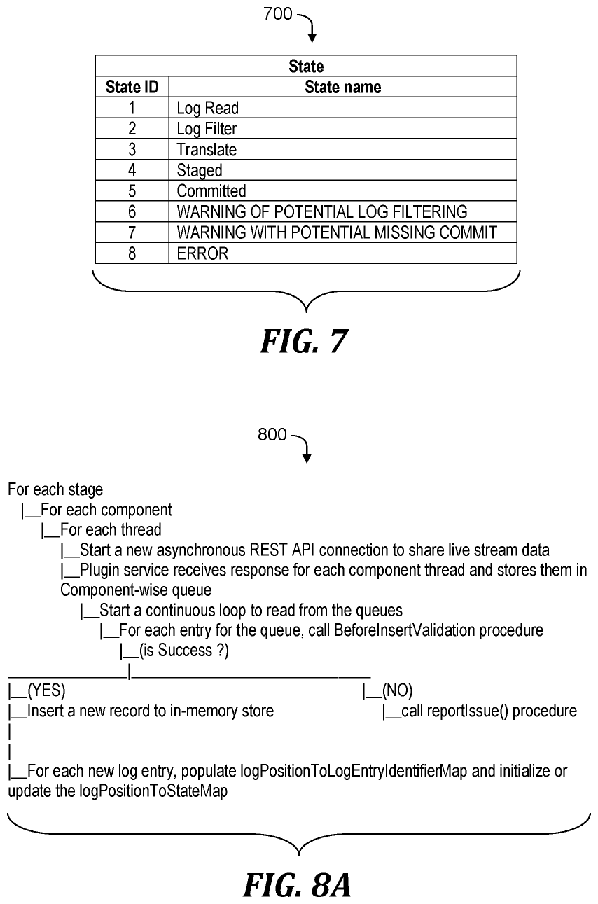

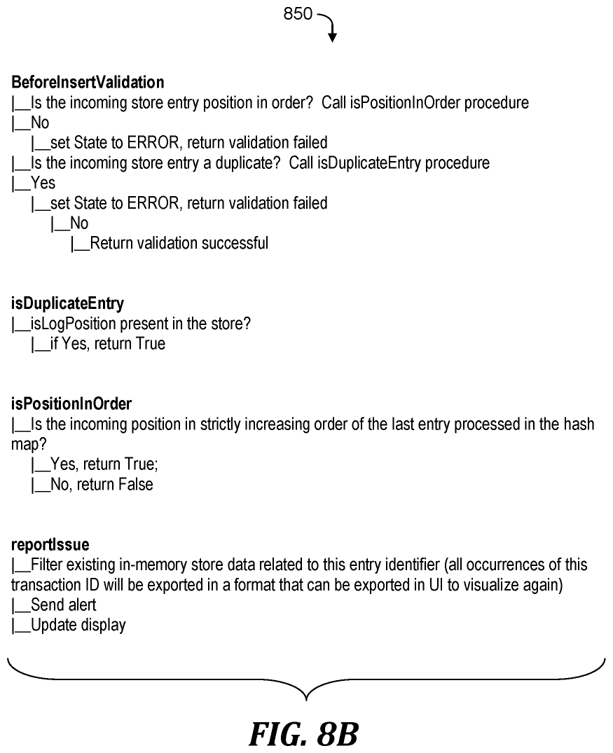

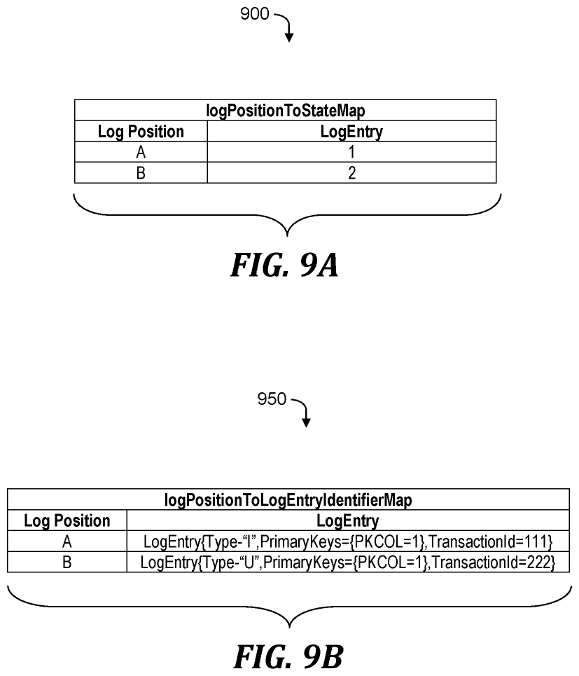

Entries in the specialized hashmaps 410 include a log position which identifies a logical record and an indication of whether the logical record associated with the log position has been successfully received or not successfully received at each component (i.e., component 401-1, . . . , component 401-N) and at target 406. Other information included in the specialized hashmaps 410 is described below relative to the discussion of FIG. 5, FIG. 6, FIG. 7, FIGS. 8A-8B, and FIGS. 9A-9B.

FIG. 5 is a block diagram of a data discrepancy detection system 500 that includes further details of the system of FIG. 4, in accordance with embodiments of the present invention. System 500 includes source database logs 502, a first hashmap 504 (also referred to as logPositionToLogEntryIdentifierMap), and a second hashmap 506 (also referred to logPositionToStateMap). System 500 sends the log positions and log entry identifiers from source database logs 502 to logPositionToLogEntryIdentifierMap. While inserting a new log entry, logPositionToLogEntryIdentifierMap checks the new log entry and ensures that only log entries in a strictly increasing order are being inserted. System 500 uses a log position compare method to perform the check of the new log entry.

A data replication pipeline starts at source database logs 502 and continues through N components: component 404-1, . . . , 404-N, where N is an integer greater than or equal to one. Component 404-1 sends a log entry to an out of order check module 508 to check if the incoming log entry is out of order (i.e., not in strict increasing order compared to the last entry processed by logPositionToLogEntryIdentifierMap). If the check by module 508 determines that the log entry is out of order, then module 508 sends the result of the check to alert and notification system 414 to generate and send an alert about the result of the check via communication system 416 (e.g., via email).

After the out of order check is completed, the out of order check module 508 sends the incoming log entry to a duplicate check module 510, which checks if the log entry is a duplicate (i.e., the log entry is already stored in logPositionToLogEntryIdentifierMap). If the log entry is a duplicate, duplicate check module 510 sends the result of its check to alert and notification system 414 to generate and send an alert about the result of the check via communication system 416.

If the out of order check module 508 and duplicate check module 510 determine that the incoming log entry is not out of order and is not a duplicate, then system 500 inserts the incoming log entry into logPositionToLogEntryIdentifierMap.

The logPositionToStateMap is a specialized hash table having two customized expiry timers: a clean-up time 512 and an inconsistency detection timer 514. System 500 sorts keys in logPositionToStateMap to identify out of order log entries. In response to entries moving to subsequent components in the replication pipeline, such as component 404-N, system 500 updates the state of the log position in logPositionToStateMap (if the update is necessary), where the log position indicates the entry that has moved to the component.

After the timer kept by clean-up timer 512 expires, system 500 automatically cleans up entries which are in committed states and entries waiting for a commit after being exported. An analysis & duplicate detection module 516 instructs alert and notification system 414 to send an alert about any entries detected that are waiting for a commit after being exported. Using the inconsistency detection timer 514, system 500 checks if the log entry is in a non-commit state for more than a specified time. If the log entry is in a non-commit state for more than the specified time, then analysis & duplicate detection module 516 instructs alert and notification system 414 to send an alert about a data loss.

Any replication product scrapes the modified logs of the source database to obtain the delta change, and then scrapes the accompanying commit log entry for the delta change to convert the delta change into a legitimate operation to be committed on the target database. An “Uncommitted Transaction Data Zone” (as described below) accumulates the delta uncommitted change. In the modified log, each log entry is identified by a log position (also referred to herein as CurrentLogPosition). The log position is used for monitoring replication progress and pausing and resuming replication. During replication, when a change log record does not fit in memory and cannot be applied because the corresponding commit is not yet received, the replication product starts accumulating the change record in a physical store. This physical store is referred to herein as the Uncommitted Transaction Data Zone.

In the discussion of FIG. 5 herein, entries read out of source database logs 502 are also referred to as log entries. Hereinafter in the discussion of FIG. 5, entries coming out of the Uncommitted Transaction Data Zone are also referred to as operations.

The order in which the delta change is obtained from the change logs may not be the same as the order in which the entries are committed. The order of commit and missing commit is one of the main reasons for data loss during replication. To simplify the process of identifying the data loss and duplicate entries, the replication flow is divided into a first stage and a second stage, as described below.

First stage: This stage starts from obtaining the delta change from source database logs 502 until the entry reaches the Uncommitted Transaction Data Zone.

Second stage: This stage starts from the Uncommitted Transaction Data Zone until the entry is applied to the target database.

The format of the log position in hashmaps 504 and 506 does not change between the first stage and the second stage. Furthermore, the order of log entries and operations inside a transaction does not vary between the first and second stages. The replication pipeline shifts from operations sorted entirely by CurrentLogPosition to operations sorted by CommitLogPosition, CurrentLogPosition between the first and second stages. In the Uncommitted Transaction Data Zone, operations can be sorted by CommitLogPosition and CurrentLogPosition.

In each of the first and second stages, system 500 detects and sends an alert about data loss and data duplication independently of the other stage. Hence, there are two different in-memory stores that store the hashmaps 504 and 506. By using two different in-memory stores, the potential data inconsistency issues are isolated and facilitates a precise analysis of the data inconsistency issues. For example, if the first stage indicates that there is a data loss, then the scope of the investigation is only the first stage, because that data has not reached the second stage. Similarly, if data loss is reported in the second stage, the scope of the investigation is limited to the second stage only because the data is already available in the Uncommitted Transaction Data Zone. If the data is available in the Uncommitted Transaction Data Zone without a commit, then the data is detected separately.

Hashmaps 504 and 506 have the following distinctive qualities:
Keys with specific log position automatically expire on a specified user-configurable interval
Keys are inserted only in the increasing order when the data replication is running, which facilitates obtaining out of order inconsistencies.
There is another expiry timer for the log entry which cleans up the log entries under any of the following conditions:
(i) the log entry's final state is reached;
(ii) the timer interval is elapsed and log entries are still waiting for a commit. System 500 sends a notification about these log entries to a user.
(iii) the timer is reset for a specific log entry if the state of the log entry is changed, thereby reducing the need for managing the received and sent time.

The plugin service between the data replication component and the application that detects and notifies the data inconsistency uses asynchronous REST API calls (e.g., the application does the handshake with the replication product as part of the plugin per component and the component returns the log entry statistics in response as part of a live stream to the application, which can use various JAVA® queues to store the log entry statistics per component. JAVA is a registered trademark of Oracle America, Inc. located in Redwood Shores, California.

In one embodiment, if Queue Full conditions exist and data inconsistency detection is slow to consume from the aforementioned queues, the inconsistency check removes the queue entries without conducting any analysis. The approach described in this paragraph avoids interfering with the live data replication.

FIG. 6 is an example 600 of hashmap specifications used in the process of FIG. 3 and the systems of FIG. 1, FIG. 4, and FIG. 5, in accordance with embodiments of the present invention. Example 600 includes a statement 602 that creates hashmap 504 (see FIG. 5) (i.e., logPositionToLogEntryIdentifierMap) and a specification 604 of logEntryIdentifier, which is the value in logPositionToLogEntryIdentifierMap. System 500 accesses the complete logEntryIdentifier only twice: once to initialize and a second time to update the actual key values when such updates are available. To save memory, the logEntryIdentifier is not repeatedly copied over; only the corresponding state in hashmap 506 (see FIG. 5) is changed.

Furthermore, example 600 includes a statement 606 that creates hashmap 506 (see FIG. 5) (i.e., logPositionToStateMap) and a specification 608 of State, which is the value in logPositionToStateMap. Still further, example 600 includes a specification 610 of LogPosition, which is a key used in both hashmap 504 and hashmap 506.

FIG. 7 is an example 700 of state names used in a hashmap included in the system of FIG. 5, in accordance with embodiments of the present invention. Example 700 includes sample state names used in hashmap 506 (see FIG. 5) (i.e., logPositionToStateMap). In one embodiment, the state names in example 700 are fixed entries in logPositionToStateMap that are decided only once. Descriptions of the sample state names included in example 700 are listed below.

Log Read: a replication state in which a log entry is generated after reading from a database log.

Log Filter: a replication state in which a log entry is filtered based on the log entry being out of replication scope.

Translate: a replication state in a given stage in which a source side log entry is translated to a log entry that can be consumed by a sink of the given stage (e.g., consumed by the Uncommitted Transaction Data Zone in the first stage or consumed by the target database (i.e., target 406 in FIG. 4) in the second stage. A known name for this component is “image builder” by which a target-compatible image is built from a source side log entry. This component is mainly used in the second stage.

Staged: a state in which the log entry has reached the destination final state of the stage and is waiting for an associated commit message. This component is for the first stage only, where the uncommitted transaction data is staged temporarily.

Committed: a log entry state in which the corresponding commit is matched and received at the destination state. In the first stage, this state indicates a situation in which commit information is received for the log entry being temporarily stored in the first stage. In the second stage, this state means the data is applied to the target database.

WARNING OF POTENTIAL LOG FILTERING: a programmed state in which a log entry is filtered out of scope, but should not have been filtered, based on the in-scope rules collected by the aforementioned plugin service between the data replication component and the application that detects and notifies about the data inconsistencies.

WARNING WITH POTENTIAL MISSING COMMIT: a programmed state in which a log entry continues to wait for commit even after a configured wait time.

ERROR: a state which indicates data duplication or data loss.

FIGS. 8A-8B is a pseudocode in a first portion 800 in FIG. 8A and a second portion 850 in FIG. 8B for a process of populating the hashmaps included in the systems of FIG. 4 and FIG. 5, in accordance with embodiments of the present invention. Portion 850 in FIG. 8B follows portion 800 in FIG. 8A. The pseudocode in FIGS. 8A and 8B illustrates plugin points of the plugin service that provides the data discrepancy detection in the data replication product. The pseudocode in FIGS. 8A-8B assumes that in each stage there are m components and there are n threads for each component doing the jobs in the data replication. In portion 800, the loop to read from the queues is set up so that when a queue is empty, the algorithm waits for a new entry in the queue.

In one embodiment, the analysis of the data being replicated and the detection of data inconsistency issues are performed by the following steps:

Step 1: An incoming entry arrives in the log reader that reads source database logs 502 (see FIG. 5).

Step 2: The in-memory store checks for the existence of the incoming entry by checking in the first or second stage record and using the procedures included in FIGS. 8A-8B.

Step 3: If the incoming entry is a new entry based on the result of Step 2, insert the new entry in logPositionToLogEntryIdentifierMap.

Step 4: else update the information in logPositionToStateMap

Step 5: Use the clean-up timer 512 (see FIG. 5) and inconsistency detection timer 514 (see FIG. 5), and analysis & duplicate detection module 516 (see FIG. 5) to perform the following validations:
Validate if the new entry is out of order. If the new entry is out of order, then change the status of the new entry (i.e., change the state in logPositionToStateMap).
Validate if an entry is continuing to wait for a commit after the configured wait time expires? If there is an entry that is continuing to wait for a commit after the expiration of the wait time, then change the status.
Validate if correct multi log record (if any) and change the status accordingly.
Validate if the new entry is correctly filtered as being out of scope and change the status accordingly.
Validate if the new entry is committed. If the new entry is committed, then delete the entry.

FIGS. 9A-9B depict examples of entries in the hashmaps 504 and 506 (see FIG. 5) included in the systems of FIG. 4 and FIG. 5, in accordance with embodiments of the present invention. The examples of entries in the hashmaps include an example 900 in FIG. 9A and an example 950 in FIG. 9B.

Example 900 includes sample entries in logPositionToStateMap (i.e., hashmap 506), which is updated every time a new state is received for a given log position. Every update for logPositionToStateMap goes through a validation for position order and for duplicate data via clean-up timer 512 (see FIG. 5) and inconsistency detection timer 514 (see FIG. 5) and an expiry check.

Example 950 includes sample entries in logPositionToLogEntryIdentifierMap (i.e., hashmap 504). The values include a primary key value, a record type such as “I,” “U,” or “D” representing insert, update, and delete, respectively, and a transaction identifier (i.e., TransactionId).

It should be noted that embodiments of the present invention support tracking whether the log filtering is done by the replication product and not by the database log reader API. Regardless of whether the tracking of log filtering is done or not, there must be tracking of when a log record in the first stage is given to a parser for parsing (e.g., by using a separate state “sent to log parser” that is recorded in the first stage table).

There will be thousands of operations arriving per second from the log reader that reads source database logs 502 (see FIG. 5) and in each component (i.e., components 404-1, . . . , 404-N), and threads lead to the multi fold entries per second to be processed by the plugin service. In one embodiment, many worker nodes working in parallel divide up each thread's work independently, except that a thread of the log reader is handled by a single worker node. For handling the log reader, a new entry position is obtained every time and for comparison, the latest of the positions is needed. If these actions use multiple threads and processes for the log reader, then the probability of entering a timing hole and a race condition is increased. To avoid these potential problems, the log reader-related processes are performed by only one thread of only one worker node, so that the worker node needs to match the speed of the log reading. In effect, this status is per log reader thread in order to maintain consistency.

For example, suppose there are two threads reading source database changes and receiving the changes as log entries and both threads have an asynchronous REST API response for a thread to update the logPositionToStateMap and insert into the logPositionToLogEntryIdentifierMap. While checking for isDuplicateEntry for inserting a new record for both of the threads:

(1) Each thread has to lock the table in order to do the duplicate check, or

(2) the duplicate check is performed on dirty data as multiple threads are updating simultaneously.

Step (1) described above may slow down the process because it is done for each new log entry. Step (2) described above defeats the purpose of detecting the out of order log entries. Hence, for each log reader thread, embodiments described herein include a separate first stage table having exclusive access to insert. Further, if there are more than one log reader threads, then there is a separate inconsistency check process.

### Detection and Reporting of Cases of Data Loss and Duplication

Out of order log entries: System 500 (see FIG. 5) detects whether log entries that are received from the source database are abnormally going back in log position.
Missing commit: System 500 detects missing commit automatically and reports the missing commit. The report error time is user configurable. The warning may be, for example, “Potential data loss may be missing commit or long transaction.”
Log parser throwing away: System 500 automatically detects this phenomenon based on detecting that a log entry is stuck at the log parser and did not reach the next state within a given wait time.
Log reader returning 0 rows: System 500 may not automatically detect a row wrongly filtered in-scoped by the log reader. System 500 can obtain an initial list of in-scope table objects and continuously build on based on the live operations. In the case of unsupported Data Definition Language operations (DDLs) (e.g., add partition), a new partition identifier (id) in the in-scope object id may not be able to be built, and therefore cannot be detected. All the operations for a particular transaction id or object id, however, can be provided for investigation.

### In-Memory Store Issues

Cleanup of In-Memory Store and Frequency of Cleanup:

In one embodiment, there is an option to clean all data except warning/error data, whereby the data is cleaned up within a specified time (e.g., within 30 minutes). In the case of a long-running transaction, the system can issue a warning or export/snapshot about the transaction.

In one embodiment, the user has options to configure the duration for which the uncommitted and data tagged with warnings need to be retained for investigation in the case of data inconsistency scenarios. Further, any log entry which reaches the committed state is eligible to be cleaned in each stage. If a log entry is cleaned in the first stage, but not in the second stage, and in the second stage the log entry is tagged with a warning, then the investigation of data duplication and data loss is done in isolation in the second stage. This approach is based on the assumption that the data that has reached the second stage has a successful first stage.

In one embodiment, live data can be retained for a maximum of 30 minutes (or another user-configurable amount of time). System 500 moves all remaining warning/error to an external report for further investigation.

In one embodiment, if a subscription is restarted, the data is built again from scratch.

Crash of in-memory store: In the event that the JAVA® process crashes, the data structure for inconsistency checking is repopulated with the data replication product's restart position when the JAVA® process restarts.

Cost of Maintenance of In-Memory Store:
For embodiments described herein, since only one copy of the log entry is maintained and only the state is updated, memory usage is controlled
In the case of the inconsistency detection application being slow in consuming the queues, then the inconsistency detection is paused momentarily and the actual data replication is not impacted.
Since embodiments described herein use in-memory storage for the customized hashmaps, I/O costs and the costs for maintaining the storage are not significant.
Since embodiments use asynchronous REST API calls to live stream the component related changes, the system is easily plugged in with cloud services

### Limitations

If apply process did not apply an operation (e.g., an update failed to update a row or failed to delete a row) and no error was returned, the system described herein does not detect this kind of data loss.

Embodiments described herein do not detect data loss due to the replication starting point being too new (i.e., the current position was incorrectly advanced), or due to the replication starting point being too old (i.e., the current position was not advanced, but it should have been advanced).

In one embodiment, the system for data discrepancy detection handles only tables that have primary keys.

Embodiments described herein do not handle multi log records whereby multiple log entries become one log operation.

The descriptions of the various embodiments of the present invention have been presented herein for purposes of illustration but are not intended to be exhaustive or limited to the embodiments disclosed. Many modifications and variations will be apparent to those skilled in the art. Accordingly, the appended claims are intended to encompass all such modifications and variations as fall within the true spirit and scope of the embodiments described herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations, which are performed during a live data replication process that includes moving logical records in a replication pipeline from a source database to a target database via one or more components:
reading a raw record from a log entry;
obtaining a logical record by converting the raw record read from the log entry;
moving the logical record in the replication pipeline so that a next component receives the logical record;
in response to obtaining or receiving the logical record, updating metadata in sorted hashmaps; and
detecting a data discrepancy between the obtained logical record and the moved logical record by analyzing the updated metadata.

2. The computer system of claim 1, wherein the computer readable code further includes the data and the instructions to cause the one or more computer processors to perform the following further operations, which are performed during the live data replication process:
generating an alert about the detected data discrepancy; and
sending the alert to a user via a communications system.

3. The computer system of claim 1, wherein the computer readable code further includes the data and the instructions to cause the one or more computer processors to perform the following further operations:
identifying a stage within the replication pipeline at which the data discrepancy occurs; and
using the identified stage, identifying a root cause of the data discrepancy.

4. The computer system of claim 3, wherein the identifying the root cause of the data discrepancy includes identifying the root cause without impacting performance measurements of the live data replication process and without impacting a completion of the live data replication process.

5. The computer system of claim 3, wherein the identifying the root cause of the data discrepancy includes identifying the root cause without performing a data comparison between the source database and the target database.

6. The computer system of claim 1, wherein the computer readable code further includes the data and the instructions to cause the one or more computer processors to perform the following further operations:
determining that the logical record does not exist in a first hash map; and
based on the logical record not already existing in the first hash map, inserting the logical record as an entry into the first hash map, the first hash map including entries having respective log positions and log entry identifiers, each log entry identifier including primary key values, a record type, and a transaction identifier, and the record type indicating an insert, an update, or a delete operation, wherein the inserting the logical record includes inserting the logical record so that log positions of the entries in the first hash map are in increasing order.

7. The computer system of claim 1, wherein the computer readable code further includes the data and the instructions to cause the one or more computer processors to perform the following further operations:
determining that the logical record exists in a first hash map; and
based on the logical record existing in the first hash map, updating information in a second hash map, wherein the first hash map includes entries having respective log positions and log entry identifiers, each log entry identifier including primary key values, a record type, and a transaction identifier, and the record type indicating an insert, an update, or a delete operation, wherein the second hash map includes entries having respective log positions and states, each state including a state identifier and a state name.

8. A computer program product comprising:
one or more computer readable storage media having computer readable program code collectively stored on the one or more computer readable storage media, the computer readable program code being executed by one or more processors of a computer system to cause the computer system to perform at least the following operations, which are performed during a live data replication process that includes moving logical records in a replication pipeline from a source database to a target database via one or more components:
reading a raw record from a log entry;
obtaining a logical record by converting the raw record read from the log entry;
moving the logical record in the replication pipeline so that a next component receives the logical record;
in response to obtaining or receiving the logical record, updating metadata in sorted hashmaps; and
detecting a data discrepancy between the obtained logical record and the moved logical record by analyzing the updated metadata.

9. The computer program product of claim 8, wherein the computer readable program code being executed by the one or more processors cause the computer system to perform the following further operations, which are performed during the live data replication process:
generating an alert about the detected data discrepancy; and
sending the alert to a user via a communications system.

10. The computer program product of claim 8, wherein the computer readable program code being executed by the one or more processors cause the computer system to perform at least the following further operations:
identifying a stage within the replication pipeline at which the data discrepancy occurs; and
using the identified stage, identifying a root cause of the data discrepancy.

11. The computer program product of claim 10, wherein the identifying the root cause of the data discrepancy includes identifying the root cause without impacting performance measurements of the live data replication process and without impacting a completion of the live data replication process.

12. The computer program product of claim 10, wherein the identifying the root cause of the data discrepancy includes identifying the root cause without performing a data comparison between the source database and the target database.

13. The computer program product of claim 8, wherein the computer readable program code being executed by the one or more processors cause the computer system to perform the following further operations:
determining that the logical record does not exist in a first hash map; and
based on the logical record not already existing in the first hash map, inserting the logical record as an entry into the first hash map, the first hash map including entries having respective log positions and log entry identifiers, each log entry identifier including primary key values, a record type, and a transaction identifier, and the record type indicating an insert, an update, or a delete operation, wherein the inserting the logical record includes inserting the logical record so that log positions of the entries in the first hash map are in increasing order.

14. The computer program product of claim 8, wherein the computer readable program code being executed by the one or more processors cause the computer system to perform the following further operations:
determining that the logical record exists in a first hash map; and
based on the logical record existing in the first hash map, updating information in a second hash map, wherein the first hash map includes entries having respective log positions and log entry identifiers, each log entry identifier including primary key values, a record type, and a transaction identifier, and the record type indicating an insert, an update, or a delete operation, wherein the second hash map includes entries having respective log positions and states, each state including a state identifier and a state name.

15. A computer-implemented method comprising:
during a live data replication process that includes moving logical records in a replication pipeline from a source database to a target database via one or more components, reading, by one or more processors, a raw record from a log entry;
obtaining, by the one or more processors and during the live data replication process, a logical record by converting the raw record read from the log entry;
moving, by the one or more processors and during the live data replication process, the logical record in the replication pipeline so that a next component receives the logical record;
in response to obtaining or receiving the logical record, updating, by the one or more processors and during the live data replication process, metadata in sorted hashmaps; and
detecting, by the one or more processors and during the live data replication process, a data discrepancy between the obtained logical record and the moved logical record by analyzing the updated metadata.

16. The method of claim 15, wherein the computer readable program code being executed by the one or more processors cause the computer system to perform the following further operations:
generating, by the one or more processors and during the live data replication process, an alert about the detected data discrepancy; and
sending, by the one or more processors and during the live data replication process, the alert to a user via a communications system.

17. The method of claim 15, wherein the computer readable program code being executed by the one or more processors cause the computer system to perform at least the following further operations:
identifying, by the one or more processors, a stage within the replication pipeline at which the data discrepancy occurs; and
using the identified stage, identifying, by the one or more processors, a root cause of the data discrepancy.

18. The method of claim 17, wherein the identifying the root cause of the data discrepancy includes identifying the root cause without impacting performance measurements of the live data replication process and without impacting a completion of the live data replication process.

19. The method of claim 17, wherein the identifying the root cause of the data discrepancy includes identifying the root cause without performing a data comparison between the source database and the target database.

20. The method of claim 15, wherein the computer readable program code being executed by the one or more processors cause the computer system to perform the following further operations:
determining that the logical record does not exist in a first hash map; and
based on the logical record not already existing in the first hash map, inserting the logical record as an entry into the first hash map, the first hash map including entries having respective log positions and log entry identifiers, each log entry identifier including primary key values, a record type, and a transaction identifier, and the record type indicating an insert, an update, or a delete operation, wherein the inserting the logical record includes inserting the logical record so that log positions of the entries in the first hash map are in increasing order.
